(19) United States
(12) Patent Application Publication
(10) Pub. No.: US 2007/0090572 A1
(43) Pub. Date: Apr. 26, 2007

(54) Pocket plate

(76) Inventor: Todd Schulze, Mooresville, NC (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/256,385

(22) Filed: Oct. 21, 2005

(51) Int. Cl. B29C 33/22; B28B 3/00

(52) U.S. Cl. 264/333; 249/139

(57) ABSTRACT

A pocket plate and method of use in conjunction with an angle-shaped form and a void filler material for facilitating the forming of a void in a concrete panel to be poured. The pocket plate comprises a table with legs made of a material that can be easily cut to adjust its height to correspond to a desired thickness of the concrete panel to be poured. An L-shaped table top portion covers a portion of the table and serves as a surface on which an edge of the angle-shaped structural member and void filler material are placed prior to pouring the concrete. The table has one or more frame members extending a predetermined distance from a vertically oriented portion of the L-shaped table top portion.

### FIELD OF THE INVENTION

The invention relates to apparatus used to form a pocket to receive and support a joist end in the tilt-up concrete construction industry.

### BACKGROUND OF THE INVENTION

In the concrete panel tilt-up business, joist pockets are commonly used. Engineers favor a joist bearing to be recessed inside the wall. The objective is to have a piece of angle-shaped steel or aluminum embedded in the concrete on which the joist or girder sits to be welded into place. The objective of the present invention is to provide a pocket plate to facilitate the proper placement of the angled member.

### SUMMARY OF THE INVENTION

The invention is a pocket plate for use in conjunction with an angle-shaped structural member and a void filler material for facilitating the forming of a void in a concrete panel to be poured and for facilitating the support of a joist or girder end.

The pocket plate comprises a table having an overall height and having supporting legs, the legs being made of a material that can be easily cut to adjust the height of the table so that when an angle-shaped structural member and a void filler material are attached to said table, the combination table, angle-shaped structural member and void filler material can correspond to a desired thickness of the concrete panel to be poured.

Typically, the angle-shaped structural member is a section of what is commonly called angle-iron or an angle bar form. Such forms are generally made of steel or aluminum material or other material compatible for welding ends of girders or structural beams. Examples of such forms used are 4 inch×4 inch angle and sometimes 3.5 inch×3.5 inch or 3 inch×3 inch forms. These forms can average from six inches long, to eight inches long, to ten inches long, to twelve inches long. The angle-shaped structural member also has means for providing a reinforcing grip within the poured concrete such as an appendage extending from the inside corner of the angle form. It is preferred that there be at least two appendages and that each appendage have an enlarged portion at its end such as a disk form. This type of stud is commonly referred to in the industry as a Nelson Stud.

The table further comprises an L-shaped table top portion covering a portion of said table. The L-shaped table top portion resembles a countertop and accordingly has a generally horizontal portion serving as a surface on which an edge of the angle-shaped structural member and void filler material are placed prior to pouring the concrete to form the concrete panel. The edge of the angle-shaped structural member, with the void filler material attached to the outside surface of the angle-shaped structural member, is rested on the generally horizontal portion adjacent to the vertically oriented portion of the L-shaped table top portion prior to pouring the concrete.

The table has spaced-apart frame members extending a predetermined distance from the vertically oriented portion of the L-shaped table top portion, wherein two of the legs are located so as to support respective ends of the spaced-apart frame members. In another embodiment, the table could have a single frame member portion and supporting legs that extends a predetermined distance from the vertically oriented portion of the L-shaped table top portion, where this single frame member extends from an approximate center of the L-shaped table top portion.

The table can be configured to have four outside legs and two additional legs at an intermediate location between the outside legs. If the table is configured to have just a single extended frame member, then the legs would typically underlie the L-shaped table top perimeter and a single leg would underlie the extended frame member.

The pocket plate is preferably made from polymeric material or other suitable materials but may also be made from metal materials. The preference for plastic materials or what is more generically referred to as polymeric material or even wood material is that the legs can be more easily adjusted in height by snipping off or cutting off or otherwise removing undesired material to shorten the overall height of the table.

Although bracing of the legs is generally not required, the pocket plate may optionally further include leg bracing means for maintaining an orientation of each leg supporting the table in a generally perpendicular orientation relative to a plane of the generally horizontal portion of the L-shaped table top portion of the table. This can be in the form of angle braces, gussets, arches extending between the legs, webbing or similar ways known in the art to brace an appendage.

The present invention further includes a method of forming a void or pocket in a concrete panel to be poured for facilitating the support of a joist or girder end in the tilt-up concrete construction industry.

The method comprises:

providing a void filler material formed for a desired width, depth and height and an angle-shaped structural member having two or more stud members extending diagonally a predetermined length inside said angle-shaped structural member;

providing a pocket plate comprising:
a table having an overall height and having spaced-apart underlying support legs, the legs being made of a material that can be easily cut to adjust the height of the table so that when the angle-shaped structural member and the void filler material are attached to said table, the combination table, angle-shaped structural member and void filler material can correspond to a desired thickness of the concrete panel to be poured;
the table further comprising an L-shaped table top portion covering a portion of said table, said L-shaped table top portion serving as a surface on which an edge of the angle-shaped structural member and void filler are placed prior to pouring the concrete to form the concrete panel; and
the table having one or more frame members extending a predetermined distance from a vertically oriented portion of the L-shaped table top portion, wherein each extended frame member has an underlying leg located so as to support a respective end of each extended frame member;

locating the void filler material on an outside surface of a leg of the angle-shaped structural member and attaching the void filler material in combination with the angle-shaped structural member on the generally horizontal portion of the L-shaped table top portion so that an edge of the outside surface of the leg of the angle-shaped structural member to which the void filler material is located rest on the generally horizontal portion adjacent to the vertically oriented portion of the table;

determining the thickness of the concrete to be poured and adjusting the overall height of the table with the void filler material and angle-shaped structural member attached thereto, so as to generally match the thickness of the concrete to be poured by removing excess material from the legs; and

placing the table with the void filler material and angle-shaped structural member attached thereto at desired locations prior to pouring the concrete.

After the panel has been poured and cured, the foam void filler material may be removed. After the panel has been position and the girders are ready to be installed, a girder end is placed inside the void and is rested on the angle form surface to which it is typically welded in place.

The void filler material is typically made from foam blocks such as STYROFOAM® material.

The void filler material and the angle-shaped structural member may be attached to the table in a number of ways, such as with the use of tape, tie-wires, electrical wire ties or similar attachment methods convenient for use in the field.

### BRIEF DESCRIPTION OF THE DRAWINGS

In the accompanying drawings:

FIG. 1 is a side view of one example of an embodiment of the present invention with the foam block and angle form tied to the inventive table;

FIG. 2a is a plan view of the inventive table of FIG. 1, with the foam block and angle form displaced;

FIG. 2b is a plan view of another embodiment of the inventive table similar to FIG. 1, except with a single extended frame member;

FIG. 3a is a side view depiction of another embodiment of the present invention with the foam and angle form displaced;

FIG. 3b is a side view depiction of the embodiment of the FIG. 2b with the foam and angle form displaced;

FIG. 4a is a conceptual depiction of the foam and angle form in place after the concrete panel has been poured with the inventive table not depicted for clarity purposes;

FIG. 4b is a conceptual depiction of the angle form in place after the concrete panel has been poured and the foam removed, with the inventive table not depicted for clarity purposes; and

FIG. 4c is a conceptual depiction of the angle form in place after the concrete panel has been poured and the foam removed with the inventive table not depicted for clarity purposes and an end of a girder is rested on the angle form leg surface.

### DETAILED DESCRIPTION OF THE INVENTION

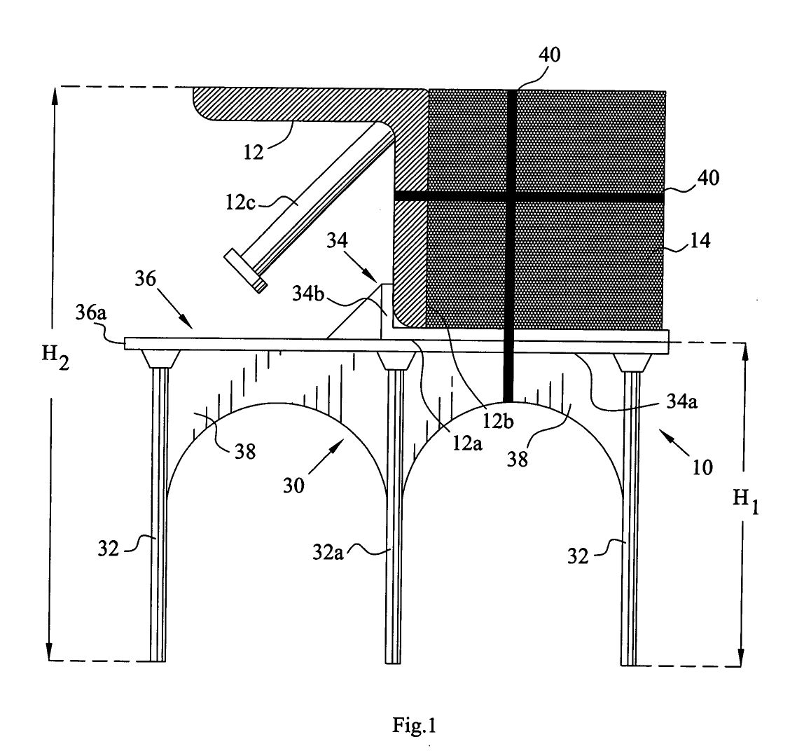

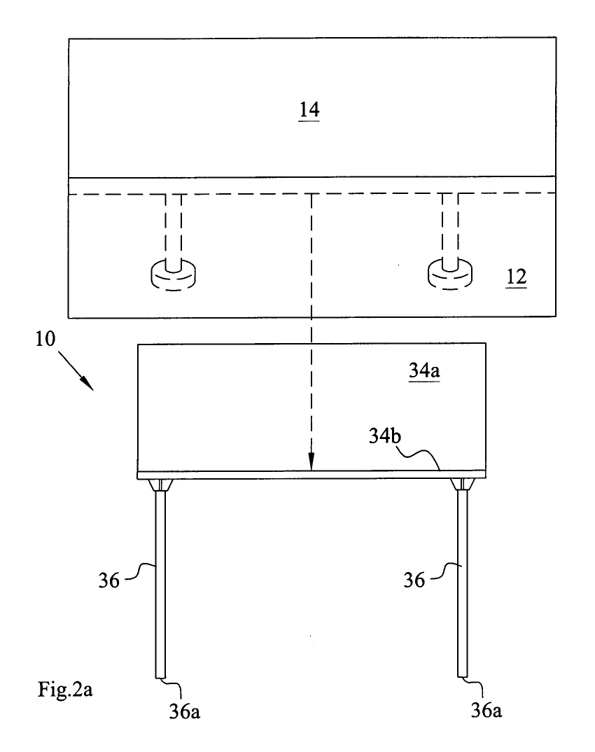

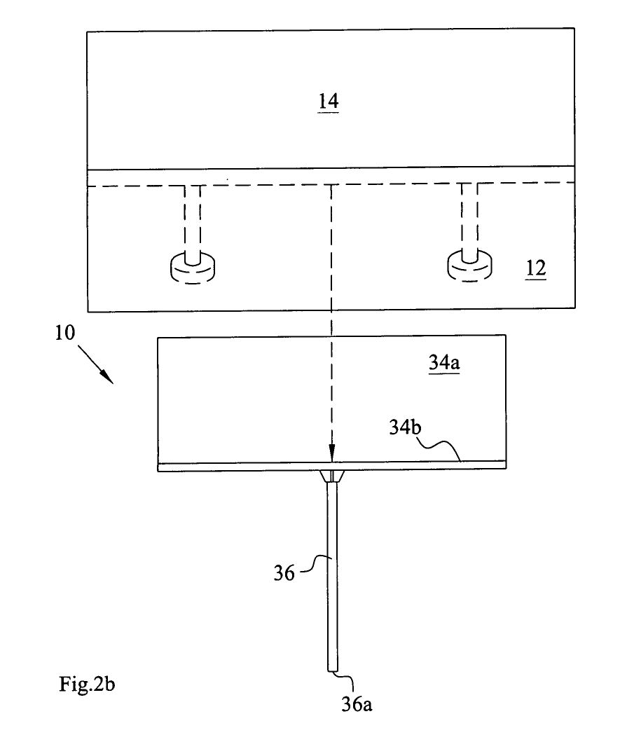

Referring now to the drawings, FIGS. 1, 2a and 2b disclose examples of various embodiments of the present invention, which is a pocket plate, depicted generally as 10.

The pocket plate 10 is used in conjunction with an angle-shaped structural member 12 and a void filler material 14 for facilitating the forming of a void 16 in a concrete panel 18 to be poured and for facilitating the support of a joist or girder end 20.

The pocket plate 10 comprises a table 30 having an overall height “H₁” and having supporting legs 32. The legs 32 are made of a material that can be easily cut to adjust the height “H₁” of the table 30 so that when the angle-shaped structural member 12 and the void filler material 14 are attached to the table 30, the combination table 30, angle-shaped structural member 12 and void filler material 14 can correspond to a desired thickness “H₂” of the concrete panel 18 to be poured.

Typically, the angle-shaped structural member 12 is a section of what is commonly called angle-iron or angle bar form. Such forms are generally made of steel or aluminum material or other material compatible for welding ends of girders or structural beams. Examples of such forms used are 4 inch×4 inch angle and sometimes 3.5 inch×3.5 inch or 3 inch×3 inch forms. These forms can average from six inches long, to eight inches long, to ten inches long, to twelve inches long. Studs or appendages 12c, typically two, preferably extend diagonally from the inside corner of the angle form 12. These may be in the form of a Nelson Stud.

The table 30 further comprises an L-shaped table top portion 34 covering a portion of said table 30. The L-shaped table top portion 34 resembles a countertop and accordingly has a generally horizontal portion 34a serving as a surface on which an edge 12a of the angle-shaped structural member 12 and void filler material 14 are placed prior to pouring the concrete to form the concrete panel 18. The edge 12a of the angle-shaped structural member 12, with the void filler material 14 attached to the outside surface 12b of the angle-shaped structural member 12, is rested on the generally horizontal portion 34a adjacent to the vertically oriented portion 34b of the L-shaped table top portion 34 prior to pouring the concrete.

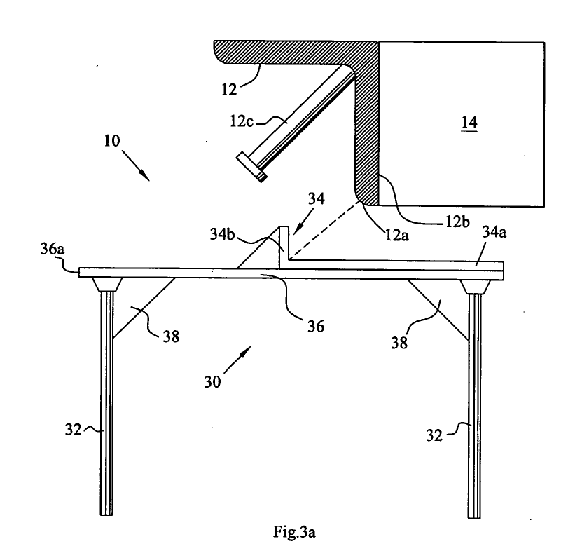

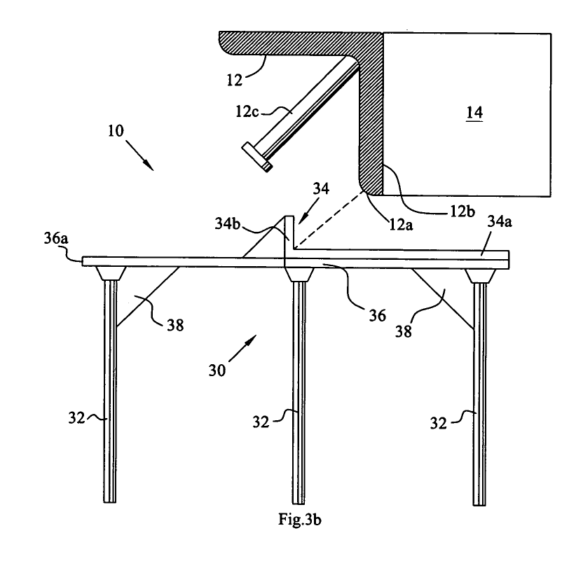

The table 30 has one or more frame members 36 extending a predetermined distance from the vertically oriented portion 34b of the L-shaped table top portion 34, wherein legs 32 are located so as to support respective ends 36a of the extended frame members 36. FIG. 3 depicts an embodiment with four legs 32, where the back two legs are not visible due to the side view depiction. FIGS. 2b and 3b depict an embodiment where there is a single extended frame member 36 extending behind the L-shaped table top portion 34 with an underlying leg 32 near the end of the frame member 36 at its end 36a.

The table 30 can be configured to have four outside legs 32 and two additional legs 32a at an intermediate location between the outside legs 32, as shown in FIG. 1. The back three legs 32,32a are not visible in FIG. 1 where it is a side view. As one can surmise by the drawings, underlying support legs can be located at any desired and convenient location to support the invention 10 while the concrete is being poured.

The pocket plate 10 is preferably made from polymeric material or wood but may also be made from metal materials. The preference for plastic materials or what is more generically referred to as polymeric material or even wood material is that the legs can be more easily adjusted in height by snipping off or cutting off or otherwise removing undesired material to shorten the overall height of the table.

Although bracing of the legs 32 is generally not required, the pocket plate may optionally further include leg bracing means 38 for maintaining an orientation of each leg 32 (32a if applicable) supporting the table 30 in a generally perpendicular orientation relative to a plane of the generally horizontal portion 34a of the L-shaped table top portion 34 of the table 30. This can be in the form of angle braces, gussets, arches extending between the legs, webbing or similar ways known in the art to brace an appendage such as a leg 32, examples of which are depicted in FIGS. 1 and 3.

The void filler material 14 and the angle-shaped structural member 12 may be attached to the table 30 in a number of ways, such as with the use of tape, tie-wires, electrical wire ties or similar attachment methods convenient for use in the field. These attachment means are collectively and generically depicted in FIG. 1 as “40.”

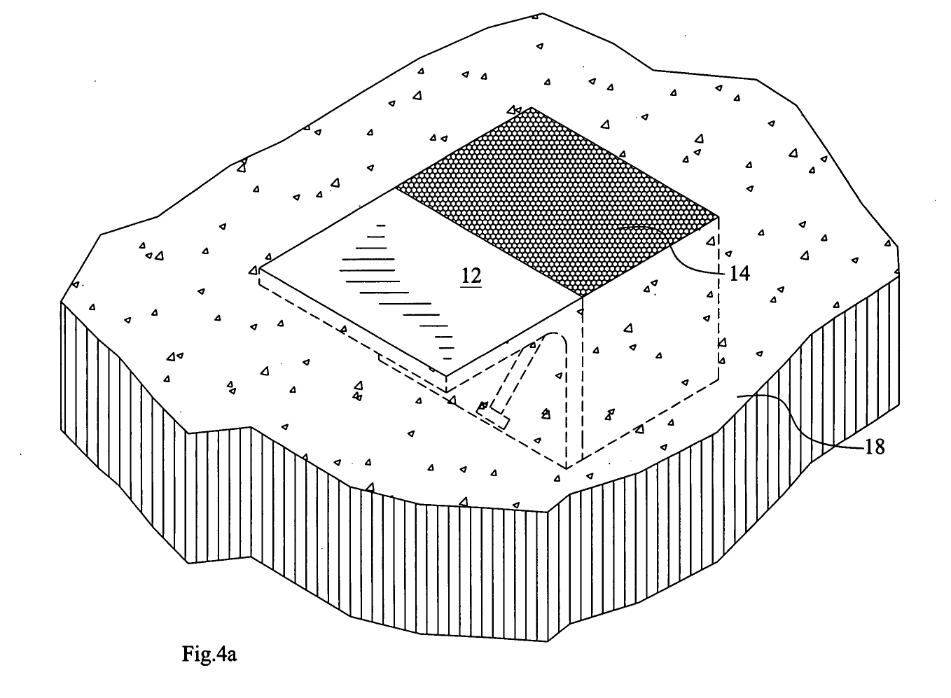

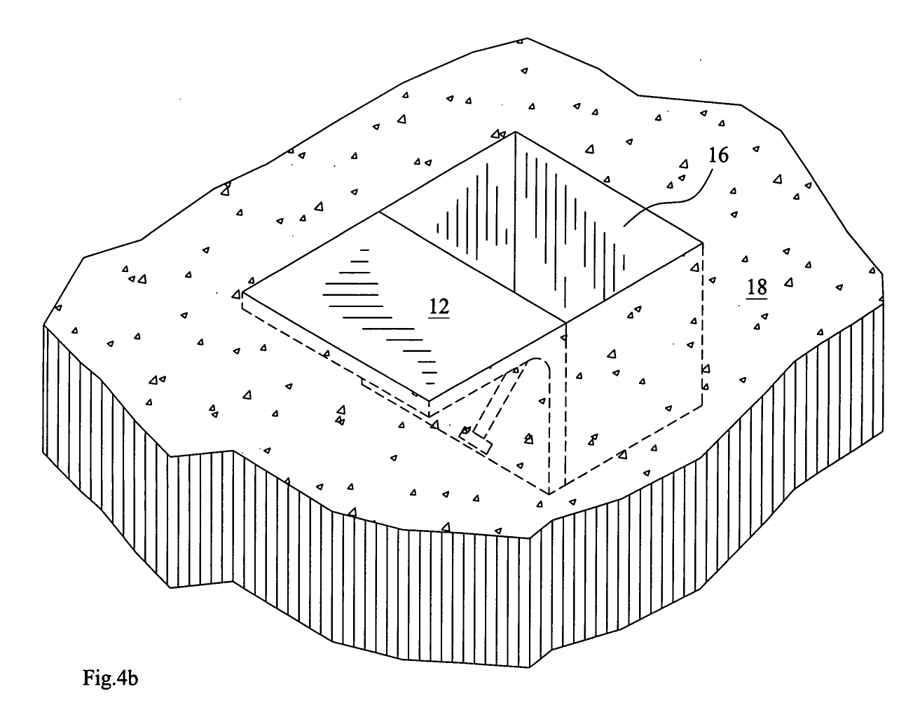

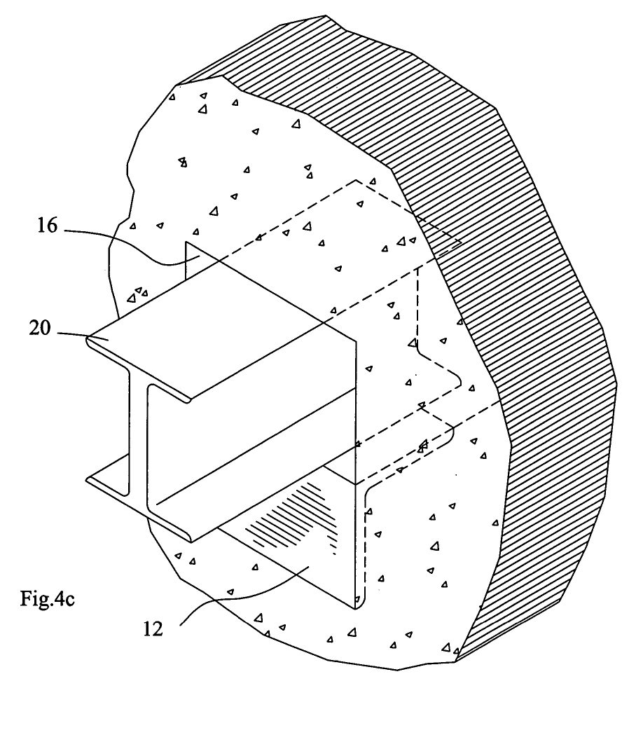

For a better understanding of the nature of the present invention 10 and how it facilitates installation of joist/girders 20 after a tilt-up concrete panel is located, FIGS. 4a-4c are presented. These drawings do not depict the invention 10 for purposes of clarity. Effectively, the inventive pocket plate 10 is buried in the poured and cured concrete and what remains is the foam 14 and angle form 12 cemented in place, as depicted in FIG. 4a. Then the foam 14 is removed creating the void 16, as conceptually depicted in FIG. 4b. As the joist/girders are ready to be installed, the end 20 of the joist/girder is placed on surface 12b of the angle form 12 and is welded in place, as conceptually depicted in FIG. 4c.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A pocket plate for use in conjunction with an angle-shaped structural member and a void filler material for facilitating the forming of a void in a concrete panel to be poured and for facilitating the support of a joist or girder end, the pocket plate comprising:
a table having an overall height and with underlying support legs, the legs being made of a material that can be easily cut to adjust the height of the table so that when an angle-shaped structural member and a void filler material are attached to said table, the combination table, angle-shaped structural member and void filler material can correspond to a desired thickness of the concrete panel to be poured;
the table further comprising an L-shaped table top portion covering a portion of said table, said L-shaped table top portion having a generally horizontal portion serving as a surface on which an edge of the angle-shaped structural member and void filler material are placed prior to pouring the concrete to form the concrete panel; and
the table having one or more frame members extending a predetermined distance from a vertically oriented portion of the L-shaped table top portion, with an underlying support leg to support an end of each extended frame member.

2. The pocket plate according to claim 1, wherein the pocket plate is made from polymeric material, wood or metal.

3. A method of forming a void in a concrete panel to be poured for facilitating the support of a joist or girder end in the tilt-up concrete construction industry, the method comprising:
providing a void filler material formed for a desired width, depth and height and an angle-shaped structural member having two or more stud members extending diagonally a predetermined length inside said angle-shaped structural member;
providing a pocket plate comprising:
a table having an overall height and having underlying support legs, the legs being made of a material that can be easily cut to adjust the height of the table so that when the angle-shaped structural member and the void filler material are attached to said table, the combination table, angle-shaped structural member and void filler material can correspond to a desired thickness of the concrete panel to be poured;
the table further comprising an L-shaped table top portion covering a portion of said table, said L-shaped table top portion serving as a surface on which an edge of the angle-shaped structural member and void filler are placed prior to pouring the concrete to form the concrete panel; and
the table having one or more frame members extending a predetermined distance from a vertically oriented portion of the L-shaped table top portion;
locating the void filler material on an outside surface of a leg of the angle-shaped structural member and attaching the void filler material in combination with the angle-shaped structural member on the generally horizontal portion of the L-shaped table top portion so that an edge of the outside surface of the leg of the angle-shaped structural member to which the void filler material is located rest on the generally horizontal portion adjacent to the vertically oriented portion of the table;
determining the thickness of the concrete to be poured and adjusting the overall height of the table with the void filler material and angle-shaped structural member attached thereto, so as to generally match the thickness of the concrete to be poured by removing excess material from the legs; and
placing the table with the void filler material and angle-shaped structural member attached thereto at desired locations prior to pouring the concrete.

4. The method according to claim 3, wherein the void filler material is made from STYROFOAM® material.

5. The method according to claim 3, wherein the table has four outside legs and two additional legs at an intermediate location between the outside legs.

6. The method according to claim 3, wherein the pocket plate is made from polymeric material, wood or metal.

7. The method according to claim 3, wherein the angle-shaped structural member has means for providing a reinforcing grip within the poured concrete.

8. The method according to claim 7, wherein said means for providing a reinforcing grip within the poured concrete comprises one or more appendages extending diagonally from an inside corner of the angle-shaped structural member.
